(19) United States
(12) Patent Application Publication
(10) Pub. No.: US 2014/0245200 A1
(43) Pub. Date: Aug. 28, 2014

(54) DISPLAY CONTROL WITH GESTURE-SELECTABLE CONTROL PARADIGMS

(71) Applicant: LEAP MOTION, INC., SAN FRANCISCO, CA (US)

(72) Inventor: David HOLZ, San Francisco, CA (US)

(73) Assignee: LEAP MOTION, INC., SAN FRANCISCO, CA (US)

(21) Appl. No.: 14/190,072

(22) Filed: Feb. 25, 2014

Related U.S. Application Data
(60) Provisional application No. 61/768,727, filed on Feb. 25, 2013.

(51) Int. Cl. G06F 3/01

(52) U.S. Cl. CPC G06F 3/017
USPC 715/764

(57) ABSTRACT

Systems and methods for dynamically displaying content in accordance with a user's manipulation of an object involve interpreting and/or displaying gestures in accordance with a control paradigm specific to the object. For example, a detected object may be compared with records in an object database, where each record in the database includes a reference object and specifies a gesture-based control paradigm specific to the reference object. The gesture-based control paradigm relates gestures performed with the reference object to contents displayable on a display, and as the user manipulates the object, the display contents change in a manner consistent with the control paradigm.

### RELATED APPLICATION

The application claims the benefit of U.S. provisional Patent Application No. 61/768,727, entitled, “DISPLAY CONTROL WITH GESTURE-SELECTABLE CONTROL PARADIGMS,” filed on Feb. 25, 2013 (Attorney Docket No. LEAP 1035-1/LPM-014PR). The provisional application is hereby incorporated by reference for all purposes.

### FIELD OF THE TECHNOLOGY DISCLOSED

The technology disclosed relates, in general, to display control, and in particular to display control based on objects within an interaction environment.

### BACKGROUND

Traditionally, users have interacted with electronic devices (such as a computer or a television) or computing applications (such as computer games, multimedia applications, or office applications) via indirect input devices, including, for example, keyboards, joysticks, or remote controllers. The user manipulates the input devices to perform a particular operation, such as selecting a specific entry from a menu of operations. Many input devices are generic across applications; for example, the function of a mouse in moving a screen cursor is the same within a word processor as it is within an Internet browser. Other devices, such as joysticks, can be primarily intended for gaming applications, and certain games can utilize dedicated peripheral devices intended for use only with the particular game.

More recently, games have been developed that sense motion and orchestrate on-screen action that is responsive to user gestures. This allows the user to control and interact with content rendered on a display screen without manipulating a pointing or other device. In some applications, however, a game piece—a gun, a bat, a golf club or other implement—is not wired to a game console but instead is optically sensed along with user gestures, and the position and manipulation of the game piece also drive the rendered action and the user's experience. In such cases, the game application “expects” to detect the presence of the game piece and reacts according to its programming logic to movements and manipulations of the game piece. The game piece, once again, is matched to the game.

Thus, peripherals and other devices that facilitate user-computer interactions tend to be fully generic across applications or highly application-specific. Consequently, control based on object movement is either generic or dictated by the application. There is no ability, with current systems, to dynamically tailor system behavior to objects as these are detected; indeed, an object-using application must generally be launched and active before anything meaningful can be done with (i.e., before the system will react to) the object.

### SUMMARY

The technology disclosed permits dynamic alteration of system behavior in response to detected objects, which are themselves used to direct action according to object-specific control paradigms. That is, once an object is detected and recognized, the manner in which movements of the object (or other moving element, such as a user's hand) within a monitored space affect system response and what is displayed depends on the object itself—that is, the system follows a control paradigm specific to the recognized object. By “control paradigm” is broadly meant any action, rule or rule set that is responsively followed based on observed motion within the monitored space, and which generally relates gestures to contents displayable on a display. A control paradigm can be, for example, a set of gestures or gesture primitives that a motion-capture system “looks for” within the space and either reacts to directly or provides to another application; a suite of gesture interpretations according to which detected movements are interpreted for higher-level processing purposes; mapping functions, such as scaling, according to which detected movements are directly translated into on-screen renderings or movements of rendered objects; or a relationship to an application that is launched in response to object detection, in which case the launched application uses detected movements in accordance with its own programming.

Thus, implementations of the technology disclosed provide systems and methods for dynamically displaying content in accordance with a user's manipulation of an object, and in particular, interpreting and/or displaying gestures based on a control paradigm specific to the object. For example, a detected object can be compared with reference objects in a database, where the database includes a at least one gesture-based control paradigm specific to each reference object. The gesture-based control paradigm can relate gestures performed with the reference object to contents displayable on a display, so that as the user manipulates the object, the display contents change in a manner consistent with the control paradigm.

Thus, gestures can have different meanings depending on the control paradigm. A squeeze of the user's hand, for example, can be interpreted as pulling a trigger in a gun paradigm, deforming a ball or other simulated elastic object in another paradigm, or zooming out of a display view in a paradigm implementing a gesture-controlled screen.

Accordingly, in a first aspect, the technology disclosed pertains to a method of dynamically displaying content in accordance with a user's manipulation of an object. In various implementations, the method comprises capturing at least one identification image of a working space; computationally analyzing the identification image(s) to identify an object therein; comparing the identified object with reference objects in a database, where the database includes at least one gesture-based control paradigm specific to each reference object. A gesture-based control paradigm can relate gestures performed with the reference object to contents displayable on a display; and if a matching reference object is found, the method can include: (i) capturing a plurality of temporally sequential working images of the object within the working space, (ii) computationally analyzing the working images to recognize therein a plurality of gestures involving the object, and (iii) modifying the display contents in accordance with the control paradigm based on the recognized gestures. If no matching object is found, execution of a default control paradigm can occur.

In various implementations, the control paradigm comprises a set of gestures and a set of control functions corresponding to the gestures, where each of the control functions is based on properties of the identified object. At least some of the object properties can be mechanical and correspond to mechanical actions performable with a physical manifestation of the object. In cases where the identification image contains a plurality of objects, the method can further include the actions of capturing a sequence of additional identification images of the working space; computationally analyzing the identification images to detect a first moving object in the working space; and selecting the first moving object as the identified object.

In some implementations, each of the objects in the database further comprises a priority level and the identification image contains a plurality of objects, and the method further comprises the actions of identifying the objects in the working space; determining the priority levels associated with the identified objects; and selecting the object having the highest priority level as the identified object. At least some of the gesture-based control paradigms in the database can be applications associated with the corresponding reference objects, in which case the method can include the action of launching the application specified for the matching reference object.

In some implementations the control paradigm dictates a scaling level, in which case the method can further include identifying a scale associated with the recognized gestures, where the scale is indicative of an actual gesture distance traversed in performance of the gesture; in such cases the method can include displaying, on a display device, movement corresponding to the gestures in accordance with the identified scale. Some or all of the object properties can be responsive to user manipulations performed on a physical manifestation of the object, in which case signals responsive to the user manipulations can be wirelessly transmitted by the physical manifestation of the object. Each of the objects in the database can include an object type further specifying characteristics of the object, in which case each of the control functions can be based also on the object type of the identified object.

In another aspect, the technology disclosed relates to a system for dynamically displaying content in accordance with a user's manipulation of an object. In various implementations, the system comprises a processor; a display and a driver therefor; at least one camera oriented toward a field of view; an object database comprising a plurality of stored objects, each of the objects including a gesture-based control paradigm specific to the reference object, the gesture-based control paradigm relating gestures performed with the reference object to contents displayable on the display; and an image analyzer executable by the processor, coupled to the camera and the database. The image analyzes can be configured to operate the camera to capture at least one identification image of a working space; computationally analyze the at least one identification image to identify an object therein; compare the identified object with objects in the database, and upon locating a reference object matching the identified object, capture a plurality of temporally sequential working images of the object within the working space, computationally analyze the working images to recognize therein a plurality of gestures involving the object, and cause the display driver to modify the display contents in accordance with the control paradigm based on the recognized gestures.

The control paradigm can comprise a set of gestures and a set of control functions corresponding to the gestures, where each of the control functions is based on properties of the identified object. At least some of the object properties can be mechanical and correspond to mechanical actions performable with a physical manifestation of the object.

In various implementations, the image analyzer is configured to recognize a plurality of objects in the identification image and thereupon cause the camera to capture a sequence of additional identification images of the working space; computationally analyze the identification images to detect a first moving object in the working space; and select the first moving object as the identified object. Each of the objects in the database can further comprise a priority level and the identification image can contain a plurality of objects, in which case the image analyzer can be further configured to identify the objects in the working space; determine the priority levels associated with the identified objects; and select the object having the highest priority level as the identified object. In some implementations, at least some of the gesture-based control paradigms in the database are applications executable by the processor and associated with the corresponding reference objects, in which case the image analyzer can be configured to cause the processor to launch the application specified. The control paradigm can dictate a scaling level, in which case the image analyzer can be further configured to identify a scale associated with the recognized gestures, the scale being indicative of an actual gesture distance traversed in performance of the gesture; and cause the display driver to modify the display contents in accordance with the identified scale. The system can include a wireless transceiver module for wirelessly communicating with a physical manifestation of the object. In some implementations, at least some of the objects in the database further comprise an object type, and the gesture-based control paradigm can be specific also to the object type of the reference object.

Reference throughout this specification to “one example,” “an example,” “one implementation,” or “an implementation” means that a particular feature, structure, or characteristic described in connection with the example is included in at least one example of the present technology. Thus, the occurrences of the phrases “in one example,” “in an example,” “one implementation,” or “an implementation” in various places throughout this specification are not necessarily all referring to the same example. Furthermore, the particular features, structures, routines, actions, or characteristics can be combined in any suitable manner in one or more examples of the technology. The headings provided herein are for convenience only and are not intended to limit or interpret the scope or meaning of the claimed technology.

These and other objects, along with advantages and features of the technology disclosed herein disclosed, will become more apparent through reference to the following description, the accompanying drawings, and the claims. Furthermore, it is to be understood that the features of the various implementations described herein are not mutually exclusive and can exist in various combinations and permutations.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1A illustrates a system for capturing image data according to an implementation of the technology disclosed.

FIG. 1B is a simplified block diagram of a system environment in which the technology disclosed can be deployed.

FIG. 2 depicts in greater detail the various components of an implementation of the technology disclosed.

FIG. 3 is a method of dynamically displaying content in accordance with a user's manipulation of an object in accordance with an implementation of the technology disclosed.

FIG. 4 illustrates one implementation of a method of interpreting gestures based at least in part upon an identity of one or more objects in space.

FIG. 5 is a flowchart showing of a method of interpreting gestures based upon an objects type determined based at least in part upon one or more fine characteristics.

### DESCRIPTION

As used herein, a given signal, event or value is “responsive to” a predecessor signal, event or value of the predecessor signal, event or value influenced by the given signal, event or value. If there is an intervening processing element, action or time period, the given signal, event or value can still be “responsive to” the predecessor signal, event or value. If the intervening processing element or action combines more than one signal, event or value, the signal output of the processing element or action is considered “dependent on” each of the signal, event or value inputs. If the given signal, event or value is the same as the predecessor signal, event or value, this is merely a degenerate case in which the given signal, event or value is still considered to be “dependent on” the predecessor signal, event or value. “Dependency” of a given signal, event or value upon another signal, event or value is defined similarly.

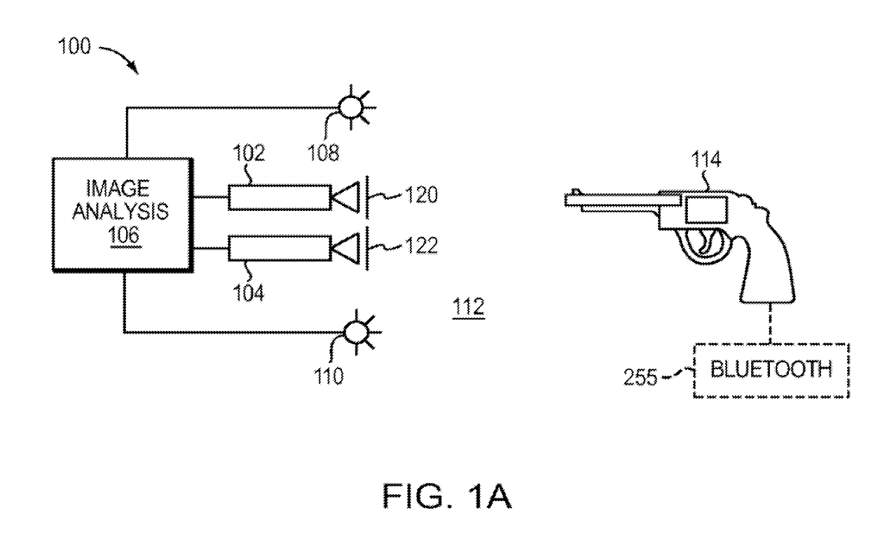

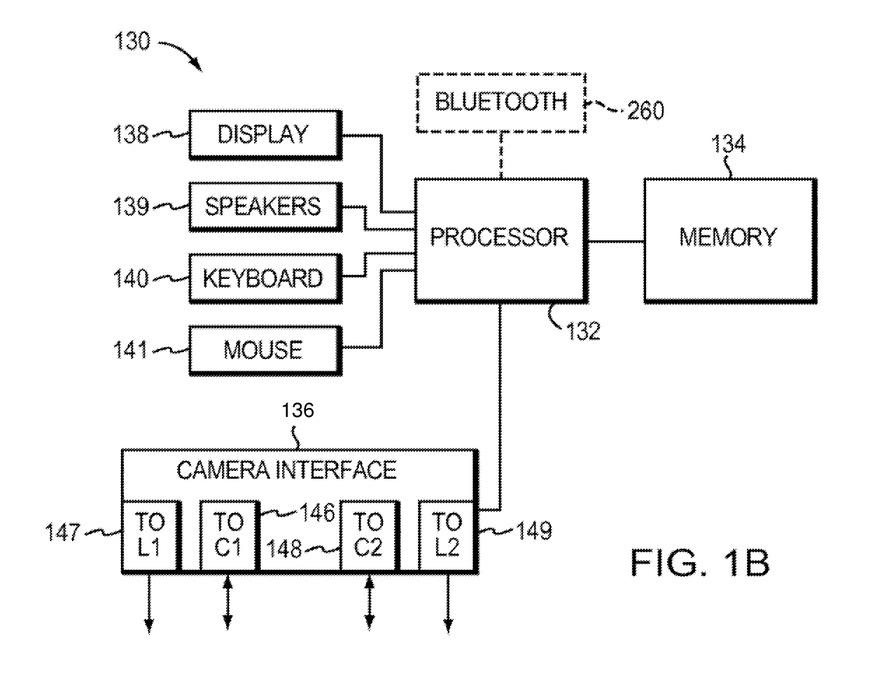

Refer first to FIG. 1A, which illustrates an exemplary gesture-recognition system 100 including any number of cameras 102, 104 coupled to an image-analysis system 106. Cameras 102, 104 can be any type of camera, including cameras sensitive across the visible spectrum or, more typically, with enhanced sensitivity to a confined wavelength band (e.g., the infrared (IR) or ultraviolet bands); more generally, the term “camera” herein refers to any device (or combination of devices) capable of capturing an image of an object and representing that image in the form of digital data. While illustrated using an example of a two camera implementation, other implementations are readily achievable using different numbers of cameras or non-camera light sensitive image sensors or combinations thereof. For example, line sensors or line cameras rather than conventional devices that capture a two-dimensional (2D) image can be employed. The term “light” is used generally to connote any electromagnetic radiation, which may or may not be within the visible spectrum, and can be broadband (e.g., white light) or narrowband (e.g., a single wavelength or narrow band of wavelengths).

Cameras 102, 104 are preferably capable of capturing video images (i.e., successive image frames at a constant rate of at least 15 frames per second), although no particular frame rate is required. The capabilities of cameras 102, 104 are not critical to the technology disclosed, and the cameras can vary as to frame rate, image resolution (e.g., pixels per image), color or intensity resolution (e.g., number of bits of intensity data per pixel), focal length of lenses, depth of field, etc. In general, for a particular application, any cameras capable of focusing on objects within a spatial volume of interest can be used. For instance, to capture motion of the hand of an otherwise stationary person, the volume of interest might be defined as a cube approximately one meter on a side.

In some implementations, the illustrated system 100 includes one or more sources 108, 110, which can be disposed to either side of cameras 102, 104 and are controlled by image-analysis system 106. In one implementation, the sources 108, 110 are light sources. For example, the light sources can be infrared light sources, e.g., infrared light-emitting diodes (LEDs), and cameras 102, 104 can be sensitive to infrared light. Use of infrared light can allow the gesture-recognition system 100 to operate under a broad range of lighting conditions and can avoid various inconveniences or distractions that can be associated with directing visible light into the region where gestures take place. However, a particular wavelength or region of the electromagnetic spectrum is required. In one implementation, filters 120, 122 are placed in front of cameras 102, 104 to filter out visible light so that only infrared light is registered in the images captured by cameras 102, 104. In another implementation, the sources 108, 110 are sonic sources providing sonic energy appropriate to one or more sonic sensors (not shown in FIG. 1A for clarity sake) used in conjunction with, or instead of, cameras 102, 104. The sonic sources transmit sound waves to the user; the user either blocks (or “sonic shadowing”) or alters the sound waves (or “sonic deflections”) that impinge upon her. Such sonic shadows and/or deflections can also be used to detect the user's gestures. In some implementations, the sound waves are, for example, ultrasound, that is not audible to humans (e.g., ultrasound).

It should be stressed that the arrangement shown in FIG. 1A is representative and not limiting. For example, lasers or other light sources can be used instead of LEDs. In implementations that include laser(s), additional optics (e.g., a lens or diffuser) can be employed to widen the laser beam (and make its field of view similar to that of the cameras). Useful arrangements can also include short- and wide-angle illuminators for different ranges. Light sources are typically diffuse rather than specular point sources; for example, packaged LEDs with light-spreading encapsulation are suitable.

In operation, light sources 108, 110 are arranged to illuminate a region of interest 112 in which an object 114 (in this example, a gun) can be present; cameras 102, 104 are oriented toward the region 112 to capture video images of the gun 114. In some implementations, the operation of light sources 108, 110 and cameras 102, 104 is controlled by the image-analysis system 106, which can be, e.g., a computer system. Based on the captured images, image-analysis system 106 determines the position and/or motion of object 114, alone or in conjunction with position and/or motion of other objects (e.g., hand holding the gun), not shown in FIG. 1A for clarity sake, from which control (e.g., gestures indicating commands) or other information can be developed.

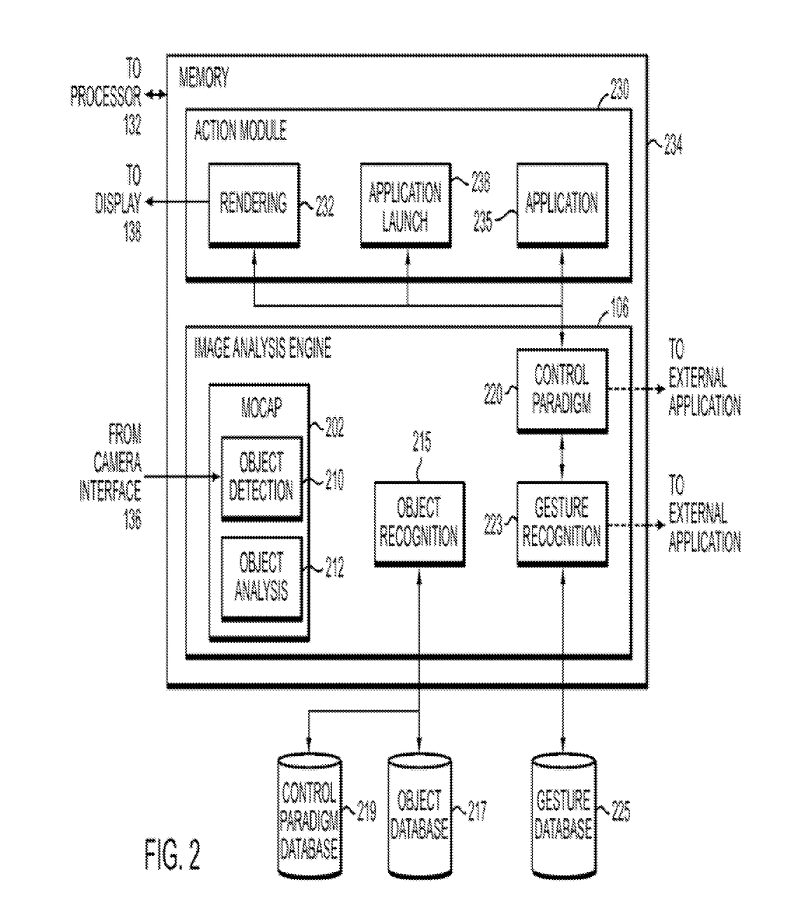

FIG. 1B is a simplified block diagram of a computer system 130, which implements image-analysis system 106 (also referred to as an image analysis engine or image analyzer) according to an implementation of the technology disclosed. Image-analysis system 106 can include or consist of any device or device component that is capable of capturing and processing image data. In some implementations, computer system 130 includes a processor 132, a memory 134, a camera interface 136, a display 138 (including a suitable driver), speakers 139, a keyboard 140, and a mouse 141. Memory 134 can be used to store instructions to be executed by processor 132 as well as input and/or output data associated with execution of the instructions. In particular, memory 134 contains instructions, conceptually illustrated in FIG. 2 as a group of modules described in greater detail below, that control the operation of processor 132 and its interaction with the other hardware components. More generally, an operating system directs the execution of low-level, basic system functions such as memory allocation, file management and operation of mass storage devices. The operating system can be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MAC OS operating system, the APACHE operating system, an OPENACTION or OPENACTION operating system, iOS, Android or other mobile operating systems, or another operating system platform.

The computing environment can also include other removable/non-removable, volatile/nonvolatile computer storage media. For example, a hard disk drive can read or write to non-removable, nonvolatile magnetic media. A magnetic disk drive can read from or writes to a removable, nonvolatile magnetic disk, and an optical disk drive can read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

Processor 132 can be a general-purpose microprocessor, but depending on implementation can alternatively be a microcontroller, peripheral integrated circuit element, a CSIC (customer-specific integrated circuit), an ASIC (application-specific integrated circuit), a logic circuit, a digital signal processor, a programmable logic device such as an FPGA (field-programmable gate array), a PLD (programmable logic device), a PLA (programmable logic array), an RFID processor, smart chip, or any other device or arrangement of devices that is capable of implementing the actions of the processes of the technology disclosed.

Camera interface 136 can include hardware and/or software that enables communication between computer system 130 and cameras such as cameras 102, 104 shown in FIG. 1A, as well as associated light sources such as light sources 108, 110 of FIG. 1A. Thus, for example, camera interface 136 can include one or more data ports 146, 148 to which cameras can be connected, as well as hardware and/or software signal processors to modify data signals received from the cameras (e.g., to reduce noise or reformat data) prior to providing the signals as inputs to a motion-capture (“mocap”) program 202 (see FIG. 2) executing on processor 132. In some implementations, camera interface 136 can also transmit signals to the cameras, e.g., to activate or deactivate the cameras, to control camera settings (frame rate, image quality, sensitivity, etc.), or the like. Such signals can be transmitted, e.g., in response to control signals from processor 132, which can in turn be generated in response to user input or other detected events.

Camera interface 136 can also include controllers 147, 149 to which light sources (e.g., light sources 108, 110) can be connected. In some implementations, controllers 147, 149 supply operating current to the light sources, e.g., in response to instructions from processor 132 executing a mocap program (as described below). In other implementations, the light sources can draw operating current from an external power supply (not shown), and controllers 147, 149 can generate control signals for the light sources, e.g., instructing the light sources to be turned on or off or changing the brightness. In some implementations, a single controller can be used to control multiple light sources.

Display 138, speakers 139, keyboard 140, and mouse 141 can be used to facilitate user interaction with computer system 130. These components can be modified as desired to provide any type of user interaction. It will be appreciated that computer system 130 is illustrative and that variations and modifications are possible. Computer systems can be implemented in a variety of form factors, including server systems, desktop systems, laptop systems, tablets, smart phones or personal digital assistants, wearable devices, e.g., goggles, head mounted displays (HMDs), wrist computers, and so on. A particular implementation can include other functionality not described herein, e.g., wired and/or wireless network interfaces, media playing and/or recording capability, etc. In some implementations, one or more cameras can be built into the computer rather than being supplied as separate components. Further, an image analyzer can be implemented using only a subset of computer system components (e.g., as a processor executing program code, an ASIC, or a fixed-function digital signal processor, with suitable I/O interfaces to receive image data and output analysis results).

While computer system 130 is described herein with reference to particular blocks, it is to be understood that the blocks are defined for convenience of description and are not intended to imply a particular physical arrangement of component parts. Further, the blocks need not correspond to physically distinct components. To the extent that physically distinct components are used, connections between components (e.g., for data communication) can be wired and/or wireless as desired.

With reference to FIG. 2, instructions defining a mocap program 202 are stored in memory 134, and these instructions, when executed, perform motion-capture analysis on images supplied from cameras connected to camera interface 136. In the illustrated implementation, mocap program 202 is part of a cluster of modules comprising the image analysis engine 106, and can include within its own functionality an object-detection module 210; in other implementations, object-detection module 210 is a stand-alone module within the analysis engine 204. Object-detection module 210 can be specialized to the application (see, e.g., U.S. Ser. No. 13/742,953, filed on Jan. 16, 2013, the entire disclosure of which is hereby incorporated by reference), can analyze images—e.g., images captured via camera interface 136—to detect edges of an object therein and/or other information about the object's location. An object-analysis module 212, also shown as within the functionality of mocap 202, can analyze the object information provided by object-detection module 210 to determine the 3D configuration, position and/or motion of object 114.

The remaining components of image analysis engine 106 are best understood in connection with operation of the system. It should be noted, however, that the illustrated component organization is representative only, and can vary depending on the desired deployment. A simple image analyzer 106 can, in some implementations, be located within a small, portable sensor device and configured to transmit image data to a separate system 130 (e.g., a computer, an advanced television, a game console, etc.) in which the processor 132 and memory 134 are located. In such configurations, the image analyzer can simply detect objects within the field of view and transmit object pixel information via a wired or wireless connection to processor 132. In other implementations, image analyzer 106 can also include mocap, object detection and object analysis capability but still be housed within the sensor device. Accordingly, the division of functionality between a device primarily deployed as a sensor and a device primarily used for display is arbitrary. Indeed, in some implementations, all of the components illustrated in FIGS. 1A, 1B and 2 are housed within a single integrated device.

In operation, image analysis engine 106 operates cameras 102, 104 to capture at least one identification image of the working space 112 in front of them. The image contains the object 114 (see FIG. 1A), which is detected by object-detection module 210. An object-recognition module 215, which can be implemented as another module of image analysis engine 106 or independently, attempts to match the detected object to objects electronically stored as templates in a database 217, which is implemented, for example, in a mass-storage device of the system 130 or on an external storage system. (As used herein, the term “electronically stored” includes storage in volatile or nonvolatile storage, the latter including disks, Flash memory, etc., and extends to any computationally addressable storage media (including, for example, optical storage).) Object templates can be stored as images and the recognized object 114 compared to the template or reference images in object database 217 using comparison algorithms. Alternatively, objects and object templates can be vectorized or otherwise compressed to reduce the computational overhead of comparison.

Each object record in database 217 includes a control paradigm (or, more typically, a pointer or link to a control paradigm stored elsewhere) associated with the object. Control paradigms are described in greater detail below; for now it suffices to note that upon matching of the detected object to an object template in database 217, the associated control paradigm is retrieved from a control-paradigm database 219 loaded into a partition of memory 134 that is hereafter referred to, for ease of explanation, as the control paradigm 220. Once again, database 219 can contain the actual data constituting the control paradigms or pointer thereto.

In further system operation, the user—typically using a hand or portion thereof, which can be interacting with the object 114—performs a gesture that is captured by the cameras 102, 104 as a series of temporally sequential images. Following object detection and identification, and loading of the control paradigm 220, images are analyzed and gestures recognized by a gesture-recognition module 223, which once again can be implemented, for example, in a mass-storage device of the system 130 or on an external storage system. For example, database 225 can store gesture templates as vectors, i.e., mathematically specified spatial trajectories, and the gesture record can have a field specifying whether the detected object must be involved in the gesture to qualify as a match. Typically, the trajectory of a sensed gesture is mathematically compared against the stored trajectories to find a best match, and the gesture is recognized as corresponding to the located database entry only if the degree of match exceeds a threshold. The gesture database 225 can be organized into a plurality of libraries each corresponding to a different control paradigm, so that the control paradigm dictates the gestures that should be expected for the detected object. In some implementations, gesture primitives—i.e., gesture components rather than complete gestures—are stored as templates in database 225. In either case, control paradigm 220 drives selection of the proper library (and, consequently, the control paradigm need not be explicitly stored in a memory partition, but instead simply read from database 219 and used in querying database 225).

Each library associates a recognized gesture to an action implemented by an action module 230, described in greater detail below. Gesture-recognition systems are well-known in the field of computer vision and can be utilized in conjunction with algorithms based on 3D models (i.e., volumetric or skeletal models), simplified skeletal models that use a simple representation of the human body or gesture-relevant body parts, or image-based models based on, for example, deformable templates of gesture-relevant body parts. For additional background information regarding visual hand gesture recognition, reference can be made to, e.g., Wu et al., “Vision-Based Gesture Recognition: A Review,” in Gesture-Based Communication in Human-Computer Interaction (Springer 1999); Pavlovic et al., “Visual Interpretation of Hand Gestures for Human-Computer Interaction: A Review,” IEEE Trans. Pattern Analysis and Machine Intelligence (19(7):677-695, July 1997).

Accordingly, a control paradigm, in the context of the technology disclosed, is broadly understood as any action, rule or rule set that is responsively followed based on observed motion within the monitored space 112, and which generally relates gestures to an action that ultimately affects contents displayable on display 138. A control paradigm can be, for example, a set of gestures or gesture primitives that gesture-recognition module 223 “looks for” within the movements followed by mocap 202 and either reacts to directly or provides to another application; a suite of gesture interpretations implemented by gesture-recognition module 223 according to which detected movements are interpreted for higher-level processing purposes; mapping functions, such as scaling, according to which detected movements are directly translated into on-screen renderings or movements of rendered objects by a rendering module 232; or a relationship to an application that is either running on the system 130 (as indicated at 235) or externally, or that is launched by an application launcher 238 in response to object detection. In any of these cases, the running application uses detected movements in accordance with its own programming based on the control paradigm, which can itself be part of the application. Accordingly, depending on how the control paradigm is used, it may not simply be stored in a memory partition.

Mapping can be implemented with mapping parameters stored in control paradigm 220. Most simply, these can represent scaling factors such that the vector of a recognized gesture is multiplied by the scaling factor and rendered accordingly by rendering module 232. Scaling is further described, for example, in U.S. Ser. No. 61/752,725, filed on Jan. 15, 2013, the entire disclosure of which is hereby incorporated by reference. In more complex implementations, object-dependent mappings reflect properties of the associated object. For example, suppose that object 114 is a pen; in this case, an arc traced by the pen (and detected and converted to a vector by mocap 202) is mapped to—i.e., causes rendering module 232 to produce—a sequence of pixels for display corresponding to a thin one-dimensional trail. If the object 114 is a paintbrush, however, an arc traced with it by a user can be mapped to a thick corresponding trail of display pixels, and the mapping can also cause rendering of animation effects such as drips. Thus, the combination of rendering module 232 and control paradigm 220 can behave as a sophisticated application, causing display of intricate, colorful, object-specific renderings in response to the object 114 and its movements within space 112.

The object can be represented at a finer level of granularity than category; for example, paintbrushes can have different shapes, sizes and stiffnesses, and these can affect display representation caused by their virtual (i.e., gestural) application by a user—i.e., the fine characteristics of the object alter the mapping accordingly. These characteristics can be detected by object-detection module 210 in any of various ways. In one implementation, the resolution of cameras 102, 104 is adequate to permit discrimination among object types as well as among objects, and objects are recognized. For example, the object templates in object database 217 can include object types rather than just objects, so that object-recognition module 215 determines the object type by database lookup. In other implementations, the object contains a code or signal—e.g., a barcode or a sequence of optically detectable etched grooves—that specify a type. In such implementations, template lookup by object-recognition module 215 can return only the object type, but lookup of the detected code in database 217 further specifies the characteristics of the object for downstream (e.g., rendering) purposes.

In various implementations, the application 235 or external application is a video game (e.g., supported by a video game console or CD or web-based video game); the user performs various gestures with object 114 to remotely interact with corresponding virtual objects shown on display 138 in the game's virtual environment. The detected gestures are provided as input parameters to the currently running game, which interprets them and takes context-appropriate action, i.e., generates screen displays responsive to the gestures. In such cases, gesture interpretation can be a function performed by the game itself, so that gesture recognition by a dedicated module 223 would actually interfere with the functioning of the game. In such cases, gesture primitives involving object 114 can be provided directly to the application by mocap 202. In this way, a user's gesture is interpreted in a context-appropriate fashion as dictated by the object and the game, which can itself have been launched in response to the object-specific control paradigm 220 invoked when the object was recognized. The division of computational responsibility between image analysis engine 106 and an internally or externally running application, as well as between hardware and software, represents a design choice.

The rendered activity will generally correspond to the detected manipulations of object 114 and, in many cases, will correspond to actions that would be performed with physical manifestations of the object. In the case of a gun object 114, for example, the physical object may not have a mechanical trigger, but gesture-recognition module 223 will recognize a finger pull as pulling a trigger and represent, on display 138, the mechanical action and the mechanical consequences—i.e., firing of the rendered gun. In some implementations, user manipulation of object 114 is detected not (or not only) by gestures detected by cameras 102, 104 and interpreted by gesture-recognition module 223, but by sensors and/or actuators on the object itself that produce a responsive output that is transmitted to processor 132. For example, gun object 114 can optionally have an internal Bluetooth transceiver module 255. When the user pulls the trigger, an actuator or sensor transmits a “trigger pull” signal to processor 132 via Bluetooth transceiver module 255. The signal reaches processor 132 via an identical or complementary Bluetooth transceiver 260, and the received signal is utilized by rendering module 232 or a running application as discussed above. More generally, the sensors and/or actuators of object 114 can be responsive to haptic user manipulations of object 114 that alter object properties as rendered or used in connection with a running application, and within the operative control paradigm. For example, while object 114 can be a generic gun, operating a switch or button on the gun can cause its rendered counterpart to toggle among various particular types of gun (e.g., a pistol, a revolver, a handgun, etc.)

Furthermore, Bluetooth communication can be bidirectional, i.e., a program running on computer system 130 can transmit a signal to object 114 causing the object to respond in some way (e.g., emit a noise or a light up). It should also be noted that Bluetooth is only one possible wireless protocol that can be used; other suitable communication protocols include Bluetooth, ZigBee, and IrDA. And depending on the system configuration and desired bandwidth, wired communication can be utilized instead of (or in addition to) wireless communication.

In some cases, working space 112 can contain multiple objects 114, and object-recognition module 215 can therefore be programmed to select the object that will be used to query database 217. In one implementation, object-detection module 210 signals camera interface 136 to continue to acquire images of the working space 112 until movement is detected by mocap 202; the first to move of the objects identified by object-detection module 210 is used by object-recognition module 215 to query reference objects in database 217. In another implementation, each object record in database 217 includes a field specifying a priority level. Object-recognition module 215 queries all detected objects against database 217 and, if multiple matches are found, the match having the highest priority level can be selected. If more than one detected object has the same priority level, the working space 112 can be monitored until one of those objects moves, and that object is selected. In still other implementations, object-specific control paradigms for more than one object are identified and used together.

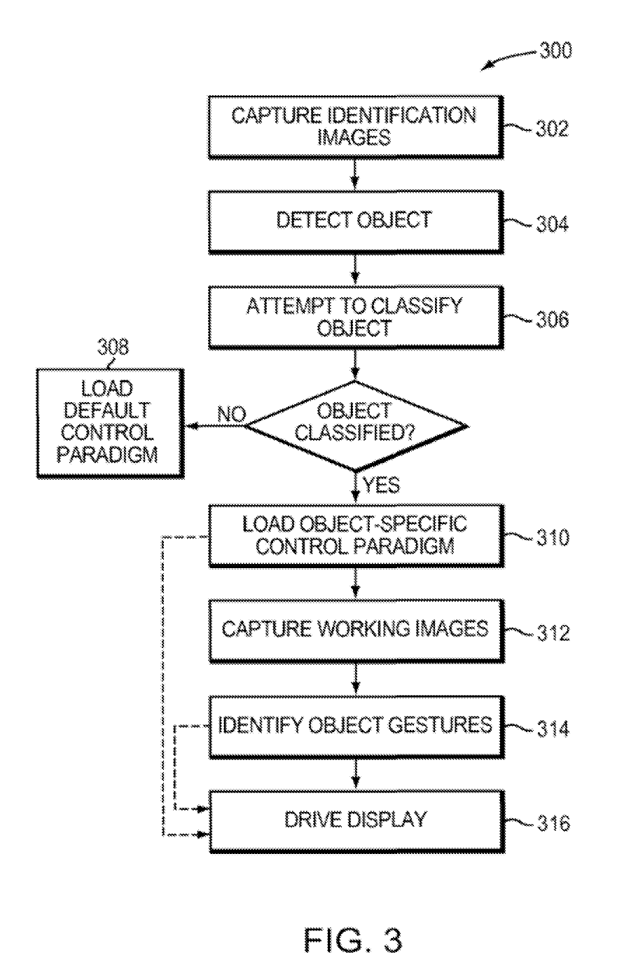

A representative method 300 shown in FIG. 3 for displaying content based on a user's manipulation of an object, and according to a control paradigm, is illustrated in FIG. 2. In a first action 302, one or more cameras are activated to capture one or more “identification images” of a working space within the field of view of the camera(s). The identification image(s) are analyzed computationally to identify the presence therein of a physical object (action 304)—i.e., the object is detected as a distinct image entity based on, for example, analysis of images, image characteristics (e.g., brightness changes, reflections or shadows, and so forth) (as described, for example, in the '953 application mentioned above. The identified object is classified by, for example, comparing it against a collection of reference objects and finding a match to a predetermined confidence level (action 306). If no matching object can be found, then a default control paradigm (or no control paradigm) is implemented (action 308). A matching reference object is associated with an object-specific control paradigm, which relates gestures performed with the reference object to contents displayable on a display. The control paradigm is obtained (e.g., directly from a database record of the reference object or using a pointer in the record) and implemented in action 310. By “implemented” is meant, for example, loaded into memory for use by a running process (e.g., as a set of mapping parameters for a rendering module), used to designate a gesture library queried by a running process for purposes of gesture recognition, or executed (e.g., causing an associated application to be launched).

A user in the working space manipulates the object, and as s/he does so, the camera(s) capture a temporal sequence of working images containing the object (action 312). These images are computationally analyzed to detect and identify movements of the object (and/or the hand interacting with the object) corresponding to gestures (action 314), and these gestures are used, in accordance with the control paradigm, to drive the contents of a display (action 316).

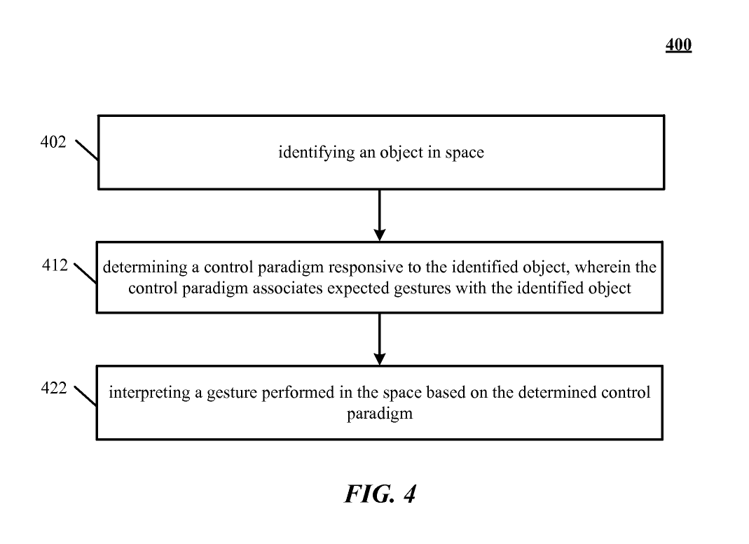

FIG. 4 illustrates of interpreting gestures based at least in part upon an identity of one or more objects in space. Flowchart 400 can be implemented at least partially with and/or by one or more processors configured to receive or retrieve information, process the information, store results, and transmit the results. Other implementations may perform the actions in different orders and/or with different, fewer or additional actions than those illustrated in FIG. 4. Multiple actions can be combined in some implementations. For convenience, this flowchart is described with reference to the system that carries out a method. The system is not necessarily part of the method.

At action 402, an object is identified in space. In one implementation, at least one identification image of the space is captured and computationally analyzed to identify an object therein. In another implementation, an object-recognition module can match the detected object to objects electronically stored as templates in a database.

At action 412, a control paradigm is determined responsive to the identified object. In some implementations, determining the control paradigm includes comparing the identified object with one or more reference objects in an object database, the database including at least one control paradigm specific to each reference object. In one implementation, the control paradigm associates expected gestures with the identified object. In another implementation, the control paradigm includes a suite of gesture interpretations used to interpret gestures performed with the identified object. In yet another implementation, on-screen responsiveness of displayed content to gestures performed with the identified object is altered, based on the control paradigm.

In other implementations, the control paradigm includes one or more rendering functions that define how at least one gestures performed with the identified object is rendered. In one implementation, the rendering function represents one or more mechanical properties characteristic of interacting with a physical manifestation of the identified object. For example, suppose that the identified object is a pen; in this case, an arc traced by the pen is mapped to a sequence of pixels for display corresponding to a thin one-dimensional trail. If the identified object is a paintbrush, however, an arc traced with it by a user can be mapped to a thick corresponding trail of display pixels, and the mapping can also cause rendering of animation effects such as drips.

In some other implementations, the control paradigm launches an application based at least in part upon the identified object in the space. In yet other implementations, the control paradigm defines a response of an application to one or more gestures performed with the identified object. In one implementation, wherein the control paradigm defines a response of one or more virtual objects in a virtual environment of the application, to one or more gestures performed with the identified object. In this way, a user's gesture is interpreted in a context-appropriate fashion as dictated by the identified object and the application e.g. a video game, which can itself have been launched in response to the determined control paradigm invoked when the object was identified.

In some implementations, the control paradigm defines one or more rendered properties of an on-screen representation of the identified object responsive to one or more manipulations of the identified object. For example, while identified object can be a generic gun, operating a switch or button on the gun can cause its rendered counterpart to toggle among various particular types of gun (e.g., a pistol, a revolver, a handgun, etc.).

According to some implementations, the control paradigm specifies a scaling level that translates an actual gesture distance traversed in performance of a gestures to a response of displayed content. In one implementation, the response of displayed content to the gesture performed with the identified object is altered based on the specified scaling level.

In some implementations, when a second object is identified in the space, a first moving object from among the identified objects is selected as the object used to determine the control paradigm. In other implementations, the method includes comparing the identified objects with one or more reference objects in an object database, the database including priority level for each control paradigm specific to each reference object and selecting a particular object with a highest priority level as the object used to determine a control paradigm.

At action 422, a gesture performed in the space is interpreted based on the determined control paradigm. For instance, if the determined control paradigm is for a gun, a squeeze of a user's hand can be interpreted as pulling a trigger in the gun. In another example, if the determined control paradigm is for a deformable ball, the squeeze of the user's hand can be interpreted as deforming the ball or other simulated elastic object. In yet another example, if the determined control paradigm is for a gesture-controlled screen, the squeeze of the user's hand can be interpreted as zooming out of a display view.

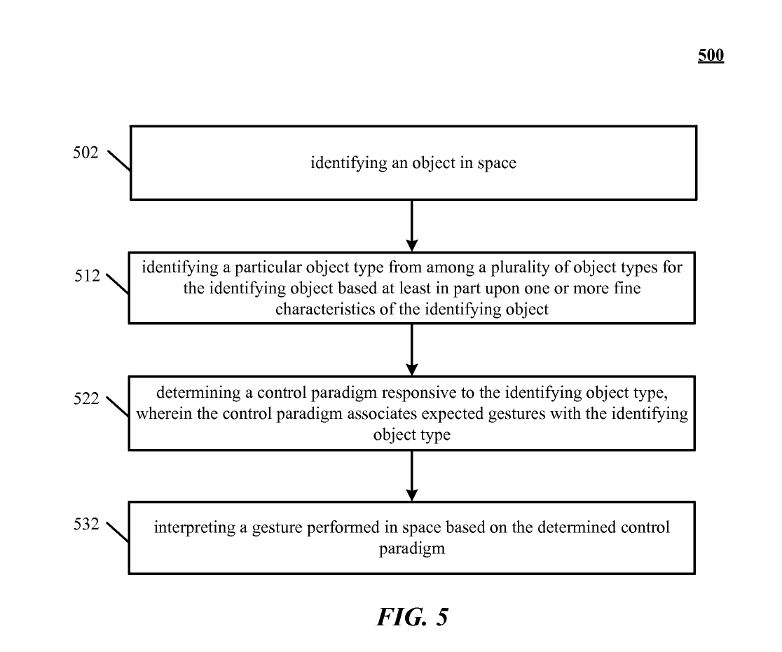

FIG. 5 is a flowchart showing of a method of interpreting gestures based upon an object type determined based at least in part upon one or more fine characteristics. Flowchart 500 can be implemented at least partially with and/or by one or more processors configured to receive or retrieve information, process the information, store results, and transmit the results. Other implementations may perform the actions in different orders and/or with different, fewer or additional actions than those illustrated in FIG. 5. Multiple actions can be combined in some implementations. For convenience, this flowchart is described with reference to the system that carries out a method. The system is not necessarily part of the method.

At action 502, an object is identified in space. In one implementation, at least one identification image of the space is captured and computationally analyzed to identify an object therein. In another implementation, an object-recognition module can match the detected object to objects electronically stored as templates in a database.

At action 512, a particular object type is detected from among a plurality of object types for the detected object based one or more fine characteristics of the detected object. This way, the identified object can be represented at a finer level of granularity than category; for example, paintbrushes can have different shapes, sizes and stiffnesses, and these can affect display representation caused by their virtual (i.e., gestural) application by a user—i.e., the fine characteristics of the object can alter the mapping accordingly. These characteristics can be detected by an object-detection module in any of various ways. In one implementation, the resolution of cameras is adequate to permit discrimination among object types as well as among objects, and objects are recognized. For example, the object templates in an object database can include object types rather than just objects, such that the object-recognition module determines the object type by database lookup. In other implementations, the object contains a code or signal—e.g., a barcode or a sequence of optically detectable etched grooves—that specify a type. In such implementations, template lookup by object-recognition module can return only the object type, but lookup of the detected code in database further specifies the characteristics of the object for downstream (e.g., rendering) purposes.

At action 512, a control paradigm is determined responsive to the identified object type. In some implementations, determining the control paradigm includes comparing the identified object type with one or more reference object types in an object type database, the database including at least one control paradigm specific to each reference object type. In one implementation, the control paradigm associates expected gestures with the identified object type. In another implementation, the control paradigm includes a suite of gesture interpretations used to interpret gestures performed with the identified object type. In yet another implementation, on-screen responsiveness of displayed content to gestures performed with the identified object type is altered based on the control paradigm.

In other implementations, the control paradigm includes one or more rendering functions that define how at least one gesture performed with the identified object type is rendered. In one implementation, the rendering functions represent mechanical properties characteristic of interacting with a physical manifestation of the identified object type. For example, suppose that the identified object type is a round paintbrush; in this case, an arc traced by the round paintbrush is mapped to a sequence of pixels for display corresponding to a thin one-dimensional trail. If the identified object type is a flat paintbrush, however, an arc traced with it by a user can be mapped to a thick corresponding trail of display pixels, and the mapping can also cause rendering of animation effects such as drips.

In some other implementations, the control paradigm launches an application based at least in part upon the identified object type in the space. In yet other implementations, the control paradigm defines response of an application to gestures performed with the identified object type. In one implementation, the control paradigm defines responsiveness of virtual objects, in a virtual environment of the application, to gestures performed with the identified object type. In this way, a user's gesture is interpreted in a context-appropriate fashion as dictated by the identified object type and the application e.g. a video game, which can itself have been launched in response to the determined control paradigm invoked when the object type was identified.

In some implementations, the control paradigm defines one or more rendered properties of an on-screen representation of the identified object type responsive to one or more manipulations of the identified object. For example, while identified object type can be a particular type of gun like a machinegun, operating a switch or button on the gun can cause its rendered counterpart to toggle among various particular types of gun (e.g., a pistol, a revolver, a handgun, etc.).

According to some implementations, the control paradigm specifies a scaling level that translates an actual gesture distance traversed in performance of a gesture to a response of displayed content. In one implementation, on-screen responsiveness of displayed content to gestures performed with the identified object type is altered based on the specified scaling level.

In some implementations, when a second object type is identified in the space, a first moving object type from among the identified object types is selected as the object type used to determine the control paradigm. In other implementations, the method includes comparing the identified object types with one or more reference object types in an object database, the database including priority level for each control paradigm specific to each reference object type and selecting a particular object type with a highest priority level as the object type used to determine a control paradigm.

At action 522, a subsequent gesture performed in the space is interpreted based on the determined control paradigm. For instance, if the determined control paradigm is for a machinegun, a squeeze of a user's hand can be interpreted as firing of multiple shots. In another example, if the determined control paradigm is for a double-barreled shotgun, the squeeze of the user's hand can be interpreted as firing of two shots. In yet another example, if the determined control paradigm is for a handgun, the squeeze of the user's hand can be interpreted as firing of a single shot.

While illustrated using an example of a relational database implementation storing objects, object types, gestures and so forth in field denominated records, other implementations are readily achievable using different data storage paradigms, e.g., in memory storage, hierarchical data trees, linked lists, object oriented databases or combinations thereof. Accordingly, the example implementations discussing records and fields are intended to be exemplary rather than limiting.

The terms and expressions employed herein are used as terms and expressions of description and not of limitation, and there is no intention, in the use of such terms and expressions, of excluding any equivalents of the features shown and described or portions thereof. In addition, having described certain implementations of the technology disclosed, it will be apparent to those of ordinary skill in the art that other implementations incorporating the concepts disclosed herein can be used without departing from the spirit and scope of the technology disclosed. Accordingly, the described implementations are to be considered in all respects as only illustrative and not restrictive.

What is claimed is:

1. A method of interpreting gestures based at least in part upon an identity of one or more objects in space, the method including:
identifying an object in space;
determining a control paradigm responsive to the identified object, wherein the control paradigm associates expected gestures with the identified object; and
interpreting a gesture performed in the space based on the determined control paradigm.

2. The method of claim 1, further including altering on-screen responsiveness of displayed content to gestures performed with the identified object, based on the control paradigm.

3. The method of claim 1, wherein determining a control paradigm further includes comparing the identified object with one or more reference objects in an object database, the database including at least one control paradigm specific to each reference object.

4. The method of claim 1, wherein the control paradigm includes a set of gesture interpretations used to interpret gestures performed with the identified object.

5. The method of claim 1, wherein the control paradigm includes one or more rendering functions that define how at least one gesture performed with the identified object is rendered.

6. The method of claim 5, wherein the rendering function represents one or more mechanical properties characteristic of interacting with a physical manifestation of the identified object.

7. The method of claim 1, wherein the control paradigm launches an application based at least in part upon the identified object in the space.

8. The method of claim 1, wherein the control paradigm defines a response of an application to one or more gestures performed with the identified object.

9. The method of claim 8, wherein the control paradigm defines a response of one or more virtual objects in a virtual environment of the application, to one or more gestures performed with the identified object.

10. The method of claim 1, wherein the control paradigm defines one or more rendered properties of an on-screen representation of the identified object responsive to one or more manipulations of the identified object.

11. The method of claim 1, wherein the control paradigm specifies a scaling level that translates an actual gesture distance traversed in performance of a gesture to a response of displayed content.

12. The method of claim 11, further including altering the response of displayed content to the gesture performed with the identified object, based on the specified scaling level.

13. The method of claim 1, further including:
identifying a second object in space; and
selecting a first moving object from among the identified objects as the object used to determine a control paradigm.

14. The method of claim 1, further including:
identifying second object in space;
comparing the identified objects with one or more reference objects in an object database, the database including priority level for each control paradigm specific to each reference object; and
selecting a particular object with a highest priority level as the object used to determine a control paradigm.

15. A method of interpreting gestures based upon an object type determined based at least in part upon one or more fine characteristics, the method including:
identifying an object in space;
identifying a particular object type from among a plurality of object types for the identified object based at least in part upon one or more fine characteristics of the identified object;
determining a control paradigm responsive to the identified object type, wherein the control paradigm associates expected gestures with the identified object type; and
interpreting a gesture performed in space based on the determined control paradigm.

16. The method of claim 15, wherein identifying a particular object type further includes comparing the identified object with object types stored in an object type database, the database including a reference object and specifying a type specific to the reference object.

17. The method of claim 15, wherein identifying a particular object type further includes:
identifying a barcode on the identified object; and
comparing the identified barcode with barcodes corresponding to one or more types of reference objects stored in an object type database, the database including a reference object and specifying one or more fine characteristics of the reference object.

18. The method of claim 15, wherein identifying a particular object type further includes:
identifying a sequence of etched grooves on the identified object; and
comparing the identified sequence with etched grooves corresponding to one or more types of reference objects stored in an object type database, the database including a reference object and specifying one or more fine characteristics of the reference object.

19. The method of claim 15, wherein one or more fine characteristics of the identified object include size of the identified object.

20. The method of claim 15, wherein one or more fine characteristics of the identified object include shape of the identified object.
